(19) United States
(12) Patent Application Publication
(10) Pub. No.: US 2014/0334701 A1
(43) Pub. Date: Nov. 13, 2014

(54) METHOD AND APPARATUS FOR CONVERGENCE GUARANTEED IMAGE RECONSTRUCTION

(71) Applicant: Korea Advanced Institute of Science and Technology, Daejeon (KR)

(72) Inventors: Jong Chul YE, Daejeon (KR); Jong Beom RA, Daejeon (KR); Kyung Sang KIM, Daejeon (KR)

(73) Assignee: Korea Advanced Institute of Science and Technology, Daejeon (KR)

(21) Appl. No.: 14/271,245

(22) Filed: May 6, 2014

(30) Foreign Application Priority Data
May 10, 2013 (KR) 10-2013-0053241
Jul. 31, 2013 (KR) 10-2013-0090625

(51) Int. Cl. G06T 17/05; G06T 11/00

(52) U.S. Cl. CPC G06T 17/05; G06T 11/006
USPC 382/131

(57) ABSTRACT

A convergence guaranteed image reconstruction method and apparatus that may compute an initial reconstruction image based on a plurality of sinograms, generate a patch-based low rank regularization image based on the initial reconstruction image, and generate a desired reconstruction image by updating the initial reconstruction image based on the patch-based low rank regularization image and an intensity lookup table.

### CROSS-REFERENCE TO RELATED APPLICATIONS

This application claims the benefit of Korean Patent Application No. 10-2013-0053241, filed on May 10, 2013, and Korean Patent Application No. 10-2013-0090625, filed on Jul. 31, 2013, in the Korean Intellectual Property Office, the disclosures of which are incorporated herein by reference.

### BACKGROUND

1. Field of the Invention

The present invention relates to positron emission tomography (PET), and more particularly, to an image reconstruction method and apparatus.

2. Description of the Related Art

Tomography refers to an imaging technique that may enable noninvasive observation of a predetermined cross section, not overlapping another adjacent cross section, of an object by rotating a detector 180 or 360 degrees (°).

A sinogram refers to a plurality of images acquired by tomography. The sinogram may be reconstructed to be a three-dimensional (3D) image. An observer may observe a predetermined cross section of an object being photographed through the reconstructed 3D image.

A nuclear medicine tomogram may refer to an image showing characteristics of distribution of a radiopharmaceutical injected into and distributed throughout a body of a person being photographed based on biochemical characteristics.

A level of radiation of the radiopharmaceutical injected into the body may be restricted based on a reference level. Thus, reconstruction of a high resolution image based on a projection value recorded by an infinitesimal number of photons may be difficult.

When tomography is performed using a nuclear medicine imaging device, noise in an observed signal may be relatively strong as compared to a weak intensity of the signal.

When frames are divided as a dynamic image, an amount of data in each frame may be overly small, and a relatively great increase in noise may occur.

In general, a dynamic image in positron emission tomography may be measured to observe metabolic functions in a predetermined area of a body. A change in metabolism may be estimated based on a time activity curve (TAC) of a corresponding area in a reconstruction image.

A number of changes may be observed within three minutes after a radiopharmaceutical is injected into a body. In this example, when a measurement interval is set to at least 30 seconds, a substantial increase in a noise ratio may occur and thus, an accurate TAC may not be measured in many cases. Accordingly, parameter values representing metabolic functions may be inaccurate, and a margin of error may increase.

A resolution-to-noise ratio of the reconstruction image may be a most significant factor in measuring metabolism through dynamic images.

An algorithm that reconstructs a positron emission tomogram (PET) may include a Poisson probability model based expectation maximization algorithm, for example, a maximum likelihood expectation maximization (MLEM) algorithm. In dynamic image reconstruction, noise in each frame image may be excessively strong. Thus, by applying Gaussian blurring to an existing reconstruction algorithm when processing a frame image, noise in the frame image may be reduced.

However, despite Gaussian blurring, a noise ratio in a reconstruction image may still be high, and a resolution of the reconstruction image may decrease due to blurring effects of Gaussian blurring.

In addition, due to noise in the image, a divergence of an image to be reconstructed may occur during an iterative operation process. To prevent the divergence of the image to be reconstructed, a method of forcibly terminating an operation after reconstructing an image is iteratively performed a number of times corresponding to a predetermined count may be used in general clinical trials.

### SUMMARY

An aspect of the present invention provides an image reconstruction method and apparatus using a patch-based low rank regularization.

Another aspect of the present invention also provides an image reconstruction method and apparatus using a patch-based low rank regularization that may have an increased operation processing rate by processing operations in parallel.

Still another aspect of the present invention also provides an image reconstruction method and apparatus using a convergence guarantee algorithm.

According to an aspect of the present invention, there is provided an image reconstruction method performed by an image reconstruction apparatus, the method including receiving a plurality of sinograms generated by measuring an object at different times, computing an initial reconstruction image based on the received sinograms, generating a patch-based low rank regularization image based on the initial reconstruction image, and updating the initial reconstruction image based on the patch-based low rank regularization image.

The initial reconstruction image may correspond to a four-dimensional (4D) image generated by individually reconstructing a plurality of three-dimensional (3D) images generated based on the plurality of sinograms for each time.

The computing may include reconstructing the plurality of 3D images into the 4D image using a probability model based expectation maximization algorithm.

The method may further include determining whether the updated reconstruction image converges.

When the updated reconstruction image does not converge, the generating and the updating may be performed iteratively.

The determining may include setting a predetermined threshold value to determine whether the updated reconstruction image converges, and verifying whether a mean square error of a difference between the initial reconstruction image yet to be updated and the updated reconstruction image is less than or equal to the threshold value.

The determining may include determining that the updated reconstruction image converges when the mean square error is less than or equal to the threshold value.

The generating may include determining a reference patch within the initial reconstruction image, collecting a predetermined number of patches most similar to the reference patch, generating a patch matrix by vectorizing the similar patches, obtaining eigenvalues of the patch matrix by performing a singular value decomposition (SVD) operation on the patch matrix, obtaining minimized eigenvalues by performing a minimization operation on the eigenvalues, and generating the patch-based low rank regularization image based on the minimized eigenvalues.

The determining of the reference patch may include generating threads corresponding to a number of pixels of the initial reconstruction image, and matching the plurality of threads to patches in which the pixels are disposed at respective centers thereof.

The plurality of threads may be processed by a plurality of cores of a graphics processing unit (GPU) of the image reconstruction apparatus, respectively.

The collecting may include identifying all adjacent temporal and spatial patches within a predetermined search area from the reference patch in the initial reconstruction image, calculating similarities between the reference patch and the adjacent temporal and spatial patches, and extracting the predetermined number of similar patches from the adjacent temporal and spatial patches based on the calculated similarities.

The obtaining of the minimized eigenvalues may include obtaining the minimized eigenvalues by eliminating eigenvalues less than or equal to a predetermined threshold value, among the eigenvalues.

The generating of the patch-based low rank regularization image based on the minimized eigenvalues may include generating a corrected matrix by multiplying the minimized eigenvalues by eigenvectors, converting columns of the corrected matrix into correction patches to be used to generate the patch-based low rank regularization image, adding each of the correction patches at a location corresponding to each of the correction patches in the initial reconstruction image, and dividing each pixel value by a number of correction patches added to each pixel, for all pixels of the initial reconstruction image to which the correction patches are added.

The updating may include acquiring an expectation maximization image of the initial reconstruction image.

The updating may include generating an intensity lookup table for a sum of a value based on the expectation maximization image, a value based on a log value of the initial reconstruction image, and a value based on the patch-based low rank regularization image.

The updating may include updating a value of the initial reconstruction image based on a value of the intensity lookup table.

The method may further include determining whether the updated value of the initial reconstruction image converges.

When the updated value of the initial reconstruction image does not converge, the generating and the updating may be performed iteratively.

The intensity lookup table may be updated each time the updating of the initial reconstruction image is performed.

A relationship between a value Tₓ^{k} of the intensity lookup table and a value x^{k+1} of an updated reconstruction image with respect to a reconstruction image x^{k} may be defined as expressed by Equation 1,

Tₓk=c₁x^{k+1}+c₂ log x^{k+1} [Equation 1]

wherein c₁ and c₂ respectively correspond to a constant value or a variable value that varies based on an iterative performance of the updating of the initial reconstruction image.

According to another aspect of the present invention, there is provided a method for convergence guaranteed image reconstruction, performed by an image reconstruction apparatus, the method including receiving a plurality of sinograms generated by measuring an object at different times, computing an initial reconstruction image based on the received sinograms, generating a patch-based low rank regularization image based on the initial reconstruction image, updating the initial reconstruction image using a convergence guarantee algorithm based on the patch-based low rank regularization image and an expectation maximization image of the initial reconstruction image, and determining whether the updated reconstruction image converges. When the updated reconstruction image does not converge, the generating and the updating may be performed iteratively.

The updating may include generating an intensity lookup table for a sum of a value based on the expectation maximization image, a value based on a log value of the initial reconstruction image, and a value based on the patch-based low rank regularization image.

The updating may include updating a value of the initial reconstruction image based on a value of the intensity lookup table. The intensity lookup table may be updated each time the updating is performed.

A relationship between a value Tₓ^{k} of the intensity lookup table and a value x^{k+1} of an updated reconstruction image with respect to a reconstruction image x^{k} is defined as expressed by Equation 2,

Tₓ_{^{k}}=c₁x^{k+1}+c₂ log x^{k+1} [Equation 2]

wherein c₁ and c₂ respectively correspond to a constant value or a variable value that varies based on an iterative performance of the updating of the initial reconstruction image.

According to still another aspect of the present invention, there is also provided an image reconstruction apparatus including a receiver to receive a plurality of sinograms generated by measuring an object at different times, a central processing unit (CPU), and a graphics processing unit (GPU). The GPU may include a plurality of cores. The CPU may compute an initial reconstruction image based on the received sinograms, generate a patch-based low rank regularization image based on the initial reconstruction image, and update the initial reconstruction image based on the patch-based low rank regularization image. The plurality of cores of the GPU may execute, in parallel, a plurality of threads to be used to compute the initial reconstruction image.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an image reconstruction apparatus according to an embodiment of the present invention;

FIG. 2 is a flowchart illustrating an image reconstruction method according to an embodiment of the present invention;

FIG. 3 is a flowchart illustrating a method of generating a patch-based low rank regularization image according to an embodiment of the present invention;

FIG. 4 is a flowchart illustrating a method of determining a reference patch within a reconstruction image according to an embodiment of the present invention;

FIG. 5 is a flowchart illustrating a method of collecting similar patches according to an embodiment of the present invention;

FIG. 6 is a flowchart illustrating a method of generating a patch-based low rank regularization image based on minimized eigenvalues according to an embodiment of the present invention;

FIG. 7 is a flowchart illustrating a method of updating a reconstruction image according to an embodiment of the present invention;

FIG. 8 is a flowchart illustrating a method of determining whether an updated reconstruction image converges according to an embodiment of the present invention; and

FIG. 9 is a flowchart illustrating a method of updating a reconstruction image using a convergence guarantee algorithm according to an embodiment of the present invention.

### DETAILED DESCRIPTION

Hereinafter, exemplary embodiments are described below to explain the present invention by referring to the accompanying drawings, wherein like reference numerals refer to the like elements throughout.

Though the present invention may be variously modified and have several embodiments, specific embodiments will be shown in drawings and be explained in detail. However, the present invention is not meant to be limited, but it is intended that various modifications, equivalents, and alternatives are also covered within the scope of the claims.

Terms used herein are to merely explain certain embodiments, not meant to limit the scope of the present invention. A singular expression includes a plural concept unless there is a contextually distinctive difference therebetween. In this description, the term “include” or “have” is intended to indicate that characteristics, numbers, steps, operations, components, elements, etc. disclosed in the specification or combinations thereof exist. As such, the term “include” or “have” should be understood that there are additional possibilities of one or more other characteristics, numbers, steps, operations, components, elements or combinations thereof.

Unless specifically defined, all the terms used herein including technical or scientific terms have the same meaning as terms generally understood by those skilled in the art. Terms defined in a general dictionary should be understood so as to have the same meanings as contextual meanings of the related art. Unless definitely defined in the present invention, the terms are not interpreted as ideal or excessively formal meanings.

Hereinafter, certain embodiments of the present invention will be explained in more detail with reference to the attached drawings. The same component or components corresponding to each other will be provided with the same reference numeral, and their detailed explanation will be omitted. When it is determined that a detailed description is related to a related known function or configuration which may make the purpose of the present disclosure unnecessarily ambiguous in the description, such a detailed description will be omitted.

Herein, the term “eigenvalue” may refer to a singular value. The terms “eigenvalue” and “singular value” may be used interchangeably. In addition, the term “image” or “value of an image” may refer to a value of each pixel of the image.

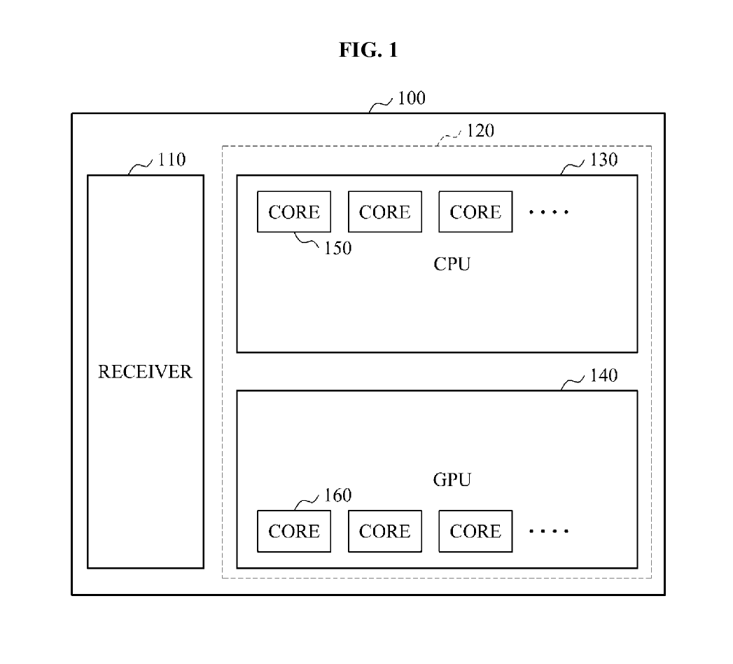

FIG. 1 is a block diagram illustrating an image reconstruction apparatus 100 according to an embodiment of the present invention.

Referring to FIG. 1, the image reconstruction apparatus 100 may include a receiver 110 and a processor 120.

The receiver 110 may receive a plurality of sinograms generated by measuring an object at different times.

The receiver 110 may receive data related to the generated sinograms via a wired or wireless network.

The processor 120 may include a central processing unit (CPU) 130, and a graphics processing unit (GPU) 140. The CPU 130 may include at least one core 150. The GPU 140 may include at least one core 160. For example, the GPU 140 may include tens to hundreds of cores 160.

The processor 120 may process operations required by the image reconstruction apparatus 100 to perform image reconstruction.

The CPU 130 may process operations required by the image reconstruction apparatus 100 to perform image reconstruction. The CPU 130 may process mathematical operations and graphics operations. The CPU 130 may control operations of the GPU 140.

The GPU 140 may process operations required by the image reconstruction apparatus 100 to perform image reconstruction. The GPU 140 may process graphics operations and mathematical operations.

The cores 150 or 160 may process in parallel operations required by the image reconstruction apparatus 100 to perform image reconstruction, respectively. To increase an operation rate of parallel processing performed by the cores 150 or 160, a frequency of data transmission and reception may be minimized. For example, when the receiver 110 receives data generated by a positron emission tomograph (PET), the receiver 110 may simultaneously receive sinograms to be used by the image reconstruction apparatus 100 to reconstruct an image before processing of operations for image reconstruction is initiated. Images reconstructed after the operations for image reconstruction are processed may be received by the receiver 110 at once when the processing of the operations is terminated.

In general, processing of a single operation performed by a core 150 or 160 may be completed in a few nanoseconds. The core 150 or 160 may require hundreds of nanoseconds or more to process a read or write operation of a memory. The plurality of cores 150 or 160 may process operations in parallel and thus, an amount of time to be used to process operations may decrease.

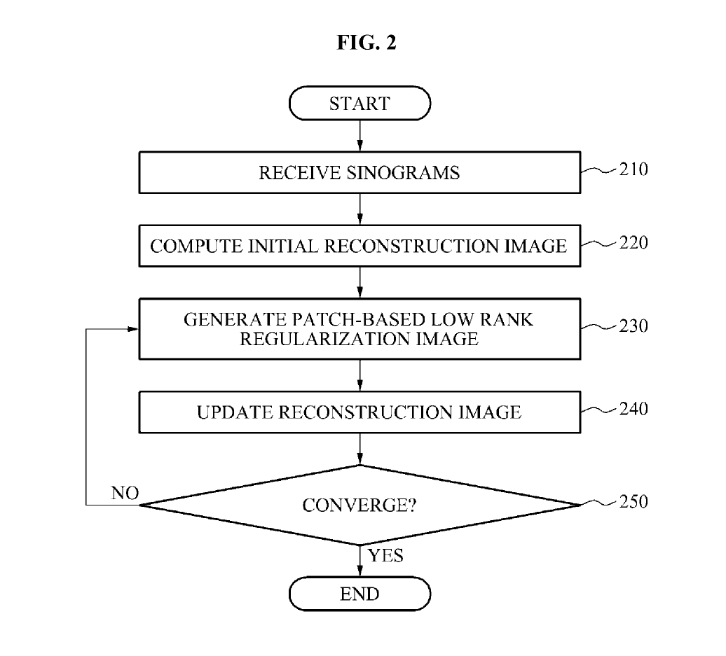

FIG. 2 is a flowchart illustrating an image reconstruction method according to an embodiment of the present invention.

Referring to FIG. 2, in operation 210, the receiver 110 of FIG. 1 may receive a plurality of sinograms generated by measuring an object at different times.

The sinograms may refer to actual images generated by measuring the object using an actual apparatus, for example, a PET. The sinograms may correspond to three-dimensional (3D) images.

The receiver 110 may receive data related to the generated sinograms. The data related to the sinograms may be transmitted from the PET, or from a separate server configured to provide data. The data related to the sinograms may include information on a temporal axis of the received sinograms. For example, the receiver 110 may receive sinograms for each frame.

In operation 220, the processor 120 of FIG. 1 may compute an initial reconstruction image based on the received sinograms. The initial reconstruction image may correspond to a four-dimensional (4D) image generated by individually reconstructing a plurality of 3D images generated based on the plurality of sinograms for each time. Hereinafter, the initial reconstruction image may also be referred to simply as the reconstruction image.

The plurality of sinograms may correspond to the plurality of 3D images, respectively. The initial reconstruction image may correspond to a 4D image generated and stored by individually reconstructing the plurality of sinograms corresponding to the 3D images for each time.

The processor 120 may reconstruct the plurality of 3D images into the 4D image using a probability model based expectation maximization algorithm. The probability model based expectation maximization algorithm may include a maximum likelihood expectation maximization (MLEM) algorithm.

The probability model based expectation maximization algorithm performed in operation 220 may be expressed by Equation 1.

$${x}_{ns}^{EM ( k + 1 )} = \frac{{x}_{ns}^{( k )}}{{\sum }_{m = 1}^{M} {a}_{mn}} {\sum }_{m = 1}^{M} \frac{{a}_{mn} {y}_{ms}}{{\sum }_{{n}^{′} = 1}^{N} {a}_{{mn}^{′}} {x}_{{n}^{′} s}^{( k )}} \qquad [ Equation 1 ]$$

In Equation 1, x denotes an image, y denotes a sinogram, and a denotes a system function.

A process of updating an image may be performed iteratively, and k denotes an iteration count. For example, k may correspond to a number of times operations 230 and 240 are performed, or a number of times operation 240 is performed.

n denotes an n-th voxel, or an index indicating the n-th voxel.

s denotes a predetermined time, and m denotes an index indicating an m-th detector.

xₙₛ^{EM(k+1)} denotes a value of a probability model based expectation maximization image of an unknown image in the n-th voxel at the time s in a (k+1)-th iteration.

xₙₛ^{(k)} denotes an unknown image in the n-th voxel at the time s in a k-th iteration.

yₘₛ denotes a value measured by the m-th detector at the time s. aₘₙ denotes a probability of a photon, emitted from the n-th voxel, being detected at a location of the m-th detector.

n′ denotes an n′-th voxel, or an index indicating the n′-th voxel.

x_{n′s}^{(k)} denotes an unknown image in the n′-th voxel at the time s in the k-th iteration.

Operations required to generate an initial reconstruction image using the probability model based expectation maximization algorithm may be processed in parallel by the cores 150 of the CPU 130 or the cores 160 of the GPU 140.

The plurality of cores 150 of the CPU 130 may execute in parallel a plurality of threads to be used to compute the initial reconstruction image.

Each core 150 may correspond to each pixel of 3D images received by the receiver 110 for each time, and may process in parallel operations required for each corresponding pixel to reconstruct the 3D images into the 4D image.

The operations required to generate the initial reconstruction image using the probability model based expectation maximization algorithm may be processed in parallel by the cores 160 of the GPU 140.

The plurality of cores 160 of the GPU 140 may execute in parallel the plurality of threads to be used to compute the initial reconstruction image.

Each core 160 may correspond to each pixel of the 3D images received by the receiver 110 for each time, and may process in parallel operations required for each corresponding pixel to reconstruct the 3D images into the 4D image.

In operation 230, the CPU 130 may generate a patch-based low rank regularization image based on the reconstruction image.

The reconstruction image used to generate the patch-based low rank regularization image may correspond to the initial reconstruction image generated in operation 220, or a reconstruction image generated after operations 240 and 250 are performed at least once.

The patch-based low rank regularization image may correspond to an image generated based on patches obtained from the reconstruction image.

A patch may refer to a block having a predetermined size in a reconstruction image. A patch-based low rank regularization image may be generated based on patches obtained from the reconstruction image. An algorithm that updates a reconstruction image based on a patch-based low rank regularization image may be employed to reduce noise in the reconstruction image.

The algorithm that reduces noise in a reconstruction image based on a patch unit may provide a more stable and increased performance, when compared to another algorithm to be used to reduce noise in a reconstruction image, for example, an algorithm that reduces noise in a reconstruction image based on a pixel unit.

The processor 120 may perform operation 230 by iteratively performing independent operations for each of the patches obtained from the reconstruction image. The independent operations may be processed in parallel by the cores 150 of the CPU 130 or the cores 160 of the GPU 140.

The patches obtained from the reconstruction image may be associated through software with threads of the GPU 140 or threads of the CPU 130, respectively.

The operations for the patches may be processed in parallel by the threads of the GPU 140 or the threads of the CPU 130, respectively.

The operations for the patches may be performed physically in succession by the CPU 130.

The operations for the patches may be performed in parallel by the cores 160 of the GPU 140 or the cores 150 of the CPU 130, respectively.

In operation 240, the processor 120 may update the reconstruction image based on the patch-based low rank regularization image generated in operation 230.

The reconstruction image to be updated in operation 240 may correspond to the initial reconstruction generated in operation 220, or a reconstruction image updated after operations 240 and 250 are performed at least one time.

Operation 240 may be performed iteratively with respect to the reconstruction image. An iterative performance of operation 240 may rely on a result of performing operation 250.

In operation 250, the processor 120 may determine whether the updated reconstruction image converges. The processor 120 may determine that the updated reconstruction image converges, or that the updated reconstruction image does not converge. Based on the determination performed by the processor 120, operations 230 and 240 may be performed iteratively when the updated reconstruction image does not converge. Operations 230 and 240 may be performed iteratively until the updated reconstruction image is determined to converge as a result of performing operation 240.

When the updated reconstruction image converges, the updated reconstruction image may correspond to a desired reconstruction image.

When the updated reconstruction image converges, operations 230 and 240 may not be performed iteratively. The processor 120 may determine whether the updated reconstruction image finally converges. When it is determined that the updated reconstruction image finally converges, the process may be terminated.

The descriptions provided with reference to FIG. 1 may be applied to the image reconstruction method of FIG. 2 and thus, duplicated descriptions will be omitted for conciseness.

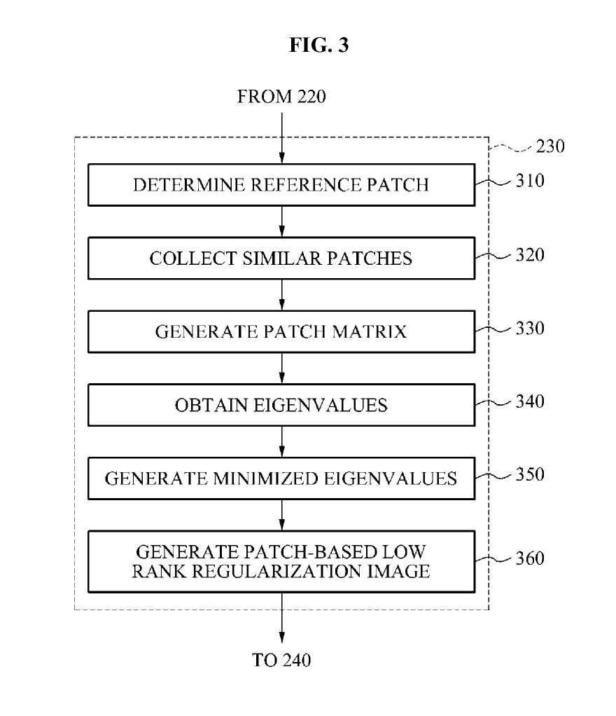

FIG. 3 is a flowchart illustrating a method of generating a patch-based low rank regularization image according to an embodiment of the present invention.

As described with reference to FIG. 2, the processor 120 may perform operation 230 of generating a patch-based low rank regularization image based on a reconstruction image. Operation 230 of FIG. 2 may include operations 310 through 360 of FIG. 3.

Referring to FIG. 3, in operation 310, the processor 120 may determine a reference patch to be used to generate a patch-based low rank regularization image.

Depending on a reconstruction image to be used to generate the patch-based low rank regularization image, at least one reference patch may exist for each pixel of the reconstruction image. For example, a plurality of reference patches may exist with respect to an identical pixel of the reconstruction image.

Reference patches may be obtained in a space. The reference patches may correspond to two-dimensional (2D) patches or 3D patches. When the reconstruction image corresponds to a dynamic image, the reference patches may be obtained on a temporal axis. The reference patches may be obtained for each frame of the dynamic image.

The reference patches may be used to obtain similar patches in operation 320.

In operation 320, the processor 120 may collect a predetermined number of patches most similar to the reference patch obtained in operation 310.

When a reconstruction image is divided into a plurality of patches, there may be patches similar to a reference patch due to a self-similarity characteristic of an image.

Similar patches may be obtained on a spatial axis. The similar patches may correspond to 2D patches or 3D patches. When the reconstruction image corresponds to a dynamic image, the similar patches may also be obtained on a temporal axis. The similar patches may be obtained for each frame of the dynamic image.

The similar patches may be used to reduce noise in the reconstruction image. The similar patches may be applied to the reconstruction image. A boundary or a shape in the reconstruction image to which the similar patches are yet to be applied may be maintained in the reconstruction image to which the similar patches are applied. Noise in the reconstruction image to which the similar patches are applied may be reduced, compared to noise in the reconstruction image to which the similar patches are yet to be applied. A method of applying the similar patches will be described in detail later.

In operation 330, the processor 120 may generate a patch matrix by vectorizing the similar patches. The similar patches may correspond to 2D patches or 3D patches. Each similar patch may be converted into a vector. The processor 120 may convert each similar patch into a 2D vector or a 3D vector.

Columns of the patch matrix may include vectors converted from the similar patches, respectively. The processor 120 may configure the vectors as the columns of the patch matrix. Similar patches obtained at an identical time may configure columns of a single patch matrix, respectively. For example, the processor 120 may obtain similar patches from each frame. The processor 120 generate a patch matrix corresponding to each frame using the similar patches obtained from each frame, with respect to each of the frames from which the similar patches are obtained.

Similar patches obtained based on an identical reference patch may configure columns of an identical patch matrix, respectively. Each set of similar patches obtained based on each reference patch may be used to generate an identical patch matrix based on the corresponding reference patch.

As described above, a patch matrix may be generated by configuring columns of the patch matrix using the vectorized similar patches. When the patch matrix is generated, the processor 120 may perform a singular value decomposition (SVD) operation to obtain eigenvalues of the patch matrix.

In operation 340, the processor 120 may obtain eigenvalues of the patch matrix by performing the SVD operation on the patch matrix.

Each column of the patch matrix to which the SVD operation is applied may correspond to a 2D vector or a 3D vector converted from a 2D similar patch or a 3D similar patch.

Frames of a dynamic image may be classified based on an order. s denotes an order of the frames of the dynamic image. s may correspond to an integer greater than or equal to “1”. An SVD operation to be performed on a patch matrix in a reference s-th frame may be defined as expressed by Equation 2.

Vₚ^{(k)}=LΣU^{H} [Equation 2]

In Equation 2, Vₚ^{(k)} denotes a patch matrix. Columns of the patch matrix Vₚ^{(k)} may correspond to vectors generated by vectorizing similar patches obtained based on a p-th reference patch in a k-th iteration.

p corresponds to an integer greater than or equal to “1”.

L denotes a square orthogonal matrix.

Σ denotes a diagonal matrix. For example, Σ may correspond to a matrix in which values of elements present on a diagonal line correspond to “0” or positive numbers, and values of all elements absent on the diagonal line correspond to “0”. The elements present on the diagonal line may have identical row numbers and identical column numbers.

Each element of the diagonal matrix Σ may correspond to a singular value of the patch matrix Vₚ^{(k)}. A number of elements of the diagonal matrix Σ may be identical to a number of singular values of the patch matrix Vₚ^{(k)}.

U^{H} denotes a conjugate transpose matrix of a matrix U. U^{H} denotes a square unitary matrix.

By decomposing the patch matrix into the aforementioned matrices using Equation 2, the eigenvalues of the patch matrix may be obtained.

Operations of Equation 2 with respect to all patch matrices may be performed in parallel by the cores 150 of the CPU 130 or the cores 160 of the GPU 140, respectively.

In operation 350, the processor 120 may obtain minimized eigenvalues by performing a minimization operation on the eigenvalues obtained through the SVD operation. The minimization operation to be performed on the eigenvalues may correspond to an operation that minimizes a number of the eigenvalues.

The processor 120 may reduce noise in the reconstruction image based on a patch unit by minimizing a rank of the patch matrix. An algorithm that reduces noise in the reconstruction image based on the patch unit by applying the similar patches and the reference patch obtained from the reconstruction image to the reconstruction image may be performed by the minimization of the rank of the patch matrix.

As described above, the rank of the patch matrix may correspond to a number of eigenvalues of the rank of the patch matrix. The minimization operation to be performed on the eigenvalues of the patch matrix may correspond to an operation that minimizes the rank of the patch matrix. The operation that minimizes the rank of the patch matrix may correspond to an operation that regularizes the rank of the patch matrix.

A first patch matrix generated from a first reconstruction image including a relatively high level of noise may include a greater number of relatively lower eigenvalues, when compared to a second patch matrix generated from a second reconstruction image including a relatively low level of noise. The relatively lower eigenvalues of the first patch matrix may correspond to eigenvalues less than or equal to a predetermined threshold value.

The processor 120 may perform the minimization operation on the eigenvalues by eliminating eigenvalues less than or equal to the predetermined threshold value, among the eigenvalues of the patch matrix. For example, the processor 120 may obtain the minimized eigenvalues by eliminating eigenvalues less than or equal to the predetermined threshold value, among the eigenvalues of the patch matrix generated from the reconstruction image.

An operation that eliminates the eigenvalues less than or equal to the predetermined threshold value, among the eigenvalues of the patch matrix, may be expressed by Equations 3 and 4.

Wₚ^{(k+1)}=Lshrink_{ν}(Σ,μ)U^{H} [Equation 3]

In Equation 3, Wₚ^{(k+1)} denotes a matrix having eigenvalues minimized by eliminating eigenvalues less than or equal to a predetermined threshold value, among eigenvalues of a patch matrix. Columns of the patch matrix may correspond to vectors generated by vectorizing similar patches obtained based on a p-th reference patch in a (k+1)-th iteration.

p corresponds to an integer greater than or equal to “1”.

L denotes a square orthogonal matrix.

shrink_{ν}(Σ, μ) denotes an element-by-element singular value shrinkage operator with respect to a diagonal matrix Σ. For example, shrink_{ν}(Σ, μ) may correspond to a matrix having the same size as the diagonal matrix Σ, and may be computed for each element.

An operation that eliminates eigenvalues less than or equal to a threshold value determined based on u and v in the matrix shrink_{ν}(Σ, μ) may be performed for each element. In this example, a value less than “0” in the matrix shrink_{ν}(Σ, μ) may be set to “0”.

Σ denotes a diagonal matrix. For example, Σ may correspond to a matrix in which values of elements present on a diagonal line correspond to “0” or positive numbers, and values of all elements absent on the diagonal line correspond to “0”. The elements present on the diagonal line may have identical row numbers and identical column numbers.

Each element of the matrix shrink_{ν}(Σ, μ) may correspond to a singular value of a matrix Wₚ^{(k+1)}. A number of elements of the matrix shrink_{ν}(Σ, μ) may be identical to a number of singular values of the matrix Wₚ^{(k+1)}.

μ denotes a predetermined value for a concave prior reconstruction result. For example, μ may range between 0.01 and 0.1.

μ denotes a factor associated with a quality of image. μ may correspond to a predetermined value selected by a trial and error method based on intensities of patches.

U^{H} denotes a conjugate transpose matrix of a matrix U. U^{H} denotes a square unitary matrix.

Wₚ and Vₚ may have different values of Σ. Wₚ may correspond to an image in which noise is reduced, when compared to Vₚ.

Operations of Equation 3 with respect to all patch matrices may be processed in parallel by the cores 150 of the CPU 130 or the cores 160 of the GPU 140.

A function shrink_{ν} used in Equation 3 to eliminate eigenvalues less than or equal to the predetermined threshold value, among the eigenvalues of the patch matrix, may be expressed by Equation 4.

shrink_{ν}(t,μ)=max{0,|t|^{ν-1}}t/|t| [Equation 4]

In Equation 4, t denotes a variable input into a shrink operator.

ν denotes a predetermined value for a concave prior reconstruction result. For example, ν may range between 0.01 and 0.1.

μ denotes a factor associated with a quality of image. μ may correspond to a predetermined value selected by a trial and error method based on intensities of patches.

The processor 120 may eliminate the eigenvalues less than or equal to the predetermined threshold value, among the eigenvalues of the patch matrix, by applying the operation of Equation 4 to the operation of Equation 3. The processor 120 may perform operation 350 by applying the operation of Equation 3 and the operation of Equation 4 to the patch matrix.

In operation 360, the processor 120 may generate a patch-based low rank regularization image based on the minimized eigenvalues.

The processor 120 may generate the patch-based low rank regularization image by applying the similar patches obtained in operation 320 to the reconstruction image.

The generated patch-based low rank regularization image may be used to perform operations 240 and 250 of FIG. 2. The patch-based low rank regularization image generated in operation 360 may correspond to a patch-based low rank regularization image generated by re-performing operation 230 after it is determined in operation 250 that the updated reconstruction image does not converge.

The descriptions provided with reference to FIGS. 1 and 2 may be applied to the method of FIG. 3 and thus, duplicated descriptions will be omitted for conciseness.

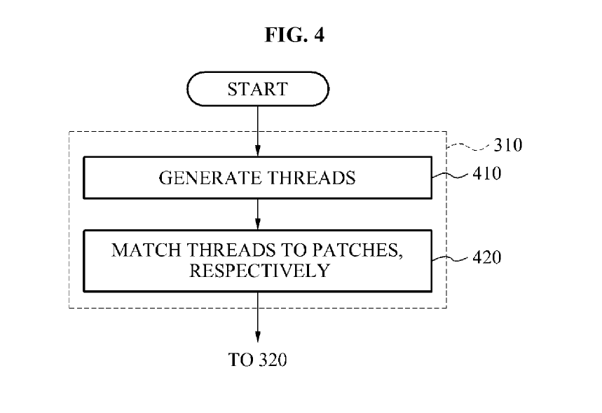

FIG. 4 is a flowchart illustrating a method of determining a reference patch within a reconstruction image according to an embodiment of the present invention.

Operation 310 of FIG. 3 may include operations 410 and 420 of FIG. 4.

Referring to FIG. 4, in operation 410, the processor 120 may generate threads corresponding to a number of pixels in a reconstruction image to determine a reference patch within the reconstruction image. A number of the generated threads may be identical to a number of reference patches.

The generated threads may be processed by the cores 160 of the GPU 140 of the image reconstruction apparatus 100.

In operation 420, the processor 120 may match the generated threads to patches in which the pixels are disposed at respective centers thereof. For example, each reference patch may correspond to one of the generated threads. The reference patches may correspond to the generated threads, respectively.

An operation or a code to be used to process each reference patch may be associated through software with a thread of the GPU 140 or a thread of the CPU 130. Operations or codes to be used to process reference patches may be processed in parallel by threads of the GPU 140 or threads of the CPU 130.

Operations for the threads corresponding to the reference patches may be processed physically in succession by the processor 130.

The operations for the threads corresponding to the reference patches may be processed in parallel by the cores 160 of the GPU 140 or the cores 150 of the CPU 130.

The cores 150 or 160 may correspond to pixels present at respective centers of the reference pixels.

The descriptions provided with reference to FIGS. 1 and 3 may be applied to the method of FIG. 4 and thus, duplicated descriptions will be omitted for conciseness.

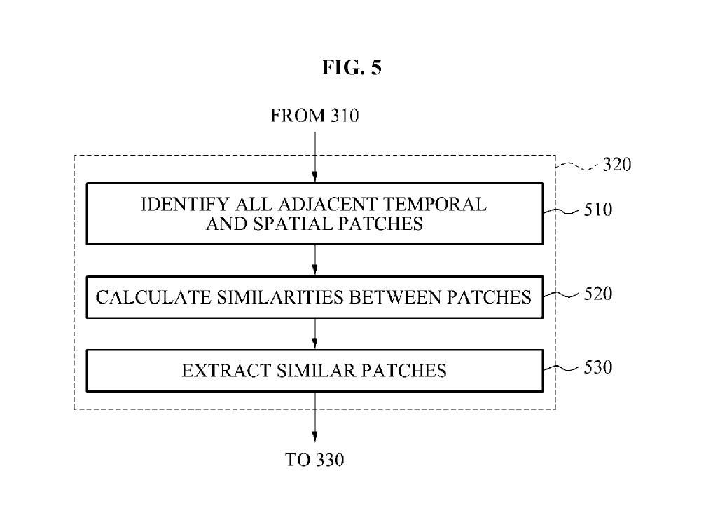

FIG. 5 is a flowchart illustrating a method of collecting similar patches according to an embodiment of the present invention.

Operation 320 of FIG. 3 may include operations 510 through 530 of FIG. 5.

Referring to FIG. 5, in operation 510, the processor 120 may identify all adjacent temporal and similar patches within a predetermined search area from a reference patch in a reconstruction image.

The predetermined search area may refer to a predetermined area present on a temporal axis and/or a spatial axis. The processor 120 may determine a range of the predetermined search area by verifying whether a similarity between reference patches is within a predetermined threshold value.

On the temporal axis, the predetermined search area may be classified for each frame.

On the spatial axis, the range of the predetermined search area may be determined based on a distance from a center of a reference patch. A pixel may be positioned at a center of a reference patch.

The processor 120 may identify all adjacent temporal and spatial patches present within the range of the predetermined search area determined on the temporal axis and/or the spatial axis based on reference patches.

In operation 520, the processor 120 may calculate similarities between the reference patch and the adjacent temporal and spatial patches.

As described above, reference patches obtained within a reconstruction image may be vectorized. For example, the reference patches may be converted into 2D vectors or 3D vectors.

A similarity between the reference patch and each of the adjacent temporal and spatial patches identified in operation 510 may correspond to a value indicating a similarity between vectorized patches. For example, the processor 120 may determine the similarity by calculating an L2-distance between the vectorized reference patch and each of the vectorized adjacent temporal and spatial patches.

In operation 530, the processor 120 may extract a predetermined number of similar patches, among the adjacent temporal and spatial patches, based on the calculated similarities.

The processor 120 may preset the predetermined number of adjacent temporal and spatial patches to be extracted as similar patches, among the adjacent temporal and spatial patches identified in operation 510. The processor 120 may preset a number of similar patches. The processor 120 may allocate an amount of a memory to be used to process the SVD operation of Equation 2 based on the preset number of similar patches.

The processor 120 may determine a number of adjacent temporal and spatial patches to be extracted as similar patches based on a predetermined threshold value of a similarity to be preset by the processor 120.

The processor 120 may extract adjacent temporal and spatial patches as similar patches, among the adjacent temporal and spatial patches identified in operation 510, in a sequence of a high similarity.

The processor 120 may extract patches as similar patches, among the identified adjacent temporal and spatial patches, when distances between the patches to be extracted and the vectorized reference patch are less than or equal to a predetermined threshold value.

When a predetermined number of adjacent temporal and spatial patches to be extracted as similar patches is preset by the processor 120, the processor 120 may extract the preset number of patches as similar patches, among the identified adjacent temporal and spatial patches, in a sequence of a close distance from the vectorized reference patch.

The descriptions provided with reference to FIGS. 1 and 4 may be applied to the method of FIG. 5 and thus, duplicated descriptions will be omitted for conciseness.

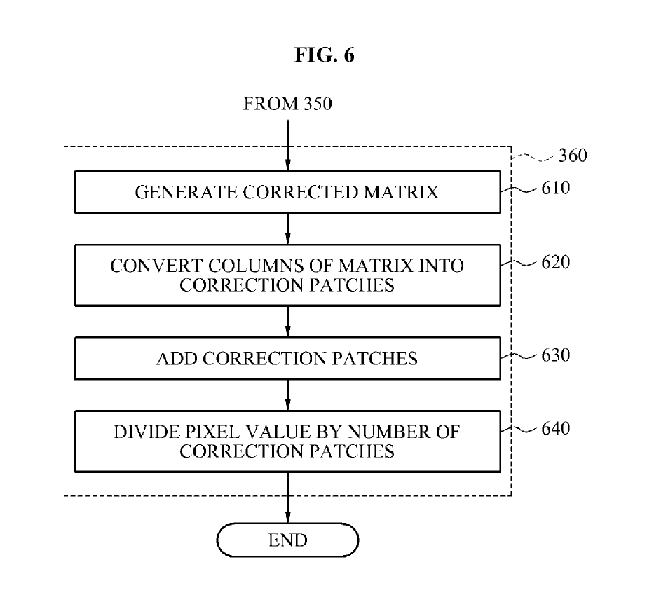

FIG. 6 is a flowchart illustrating a method of generating a patch-based low rank regularization image based on minimized eigenvalues according to an embodiment of the present invention.

Operation 360 of FIG. 3 may include operations 610 through 640 of FIG. 6.

Referring to FIG. 6, in operation 610, the processor 120 may generate a corrected matrix by multiplying minimum eigenvalues by eigenvectors.

As described with reference to operation 350 of FIG. 3, the processor 120 may eliminate eigenvalues less than or equal to a predetermined threshold value using Equations 3 and 4. By eliminating the eigenvalues less than or equal to the predetermined threshold value, the processor 120 may minimize eigenvalues of a patch matrix. The processor 120 may obtain minimized eigenvectors of the patch matrix based on the minimized eigenvalues. The minimized eigenvectors may be associated with the minimized eigenvalues, respectively. The minimized eigenvectors may be paired with the minimized eigenvalues, respectively. The processor 120 may obtain vectors by multiplying a minimized eigenvector by a minimized eigenvalue being paired with the minimized eigenvector, among the minimized eigenvectors and the minimized eigenvalues. Each obtained vector may configure each column of the corrected matrix generated in operation 610. The processor 120 may generate the corrected matrix using the obtained vectors as columns of the corrected matrix, and the columns of the corrected matrix may correspond to the obtained vectors, respectively.

In operation 620, the processor 120 may convert the columns of the corrected matrix into correction patches to be used to generate a patch-based low rank regularization image.

Each column of the corrected matrix may correspond to a vector to be used to generate the patch-based low rank regularization image. A vector configuring each column of the corrected matrix may correspond to a 2D vector or a 3D vector. The 2D vector or the 3D vector configuring each column of the corrected matrix may be converted into a 2D correction patch or a 3D correction patch. When the corrected matrix includes columns configured using 2D vectors, the column of the corrected matrix may be converted into 2D correction patches. When the corrected matrix includes columns configured using 3D vectors, the columns of the corrected matrix may be converted into 3D correction patches.

In operation 630, the processor 120 may add each of the correction patches at a location corresponding to each of the correction patches in the reconstruction image.

In operation 640, the processor 120 may divide each pixel value by a number of correction patches added to each pixel, for all pixels of the reconstruction image.

Similar to a plurality of similar patches obtained by performing operations 510 through 530 of FIG. 5 on a single reference patch, a plurality of correction patches obtained through operation 620 may be present for the single reference patch. Since the plurality of similar patches may be present within a predetermined search range from the single reference patch, a plurality of overlapping patches may be applied to a portion of pixels in the reconstruction image. Similarly, since the plurality of correction patches may be present within the predetermined search range from the single reference patch, overlapping patches may be applied to a portion of pixels in the reconstruction image.

Similar to applying an identical number of patches to each pixel of the reconstruction image, the processor 120 may generate a desired patch-based low rank regularization image by correcting values of the correction patches to be added to each pixel. Similar to applying a single correction patch to each pixel of the reconstruction image, the processor 120 may correct values of overlapping correction patches to be applied to each pixel of the reconstruction image.

The processor 120 may divide each pixel value by a number of correction patches added to each pixel, for all pixels of the reconstruction image to which the overlapping correction patches are applied. The number of correction patches may correspond to a number of overlapping correction patches applied to each pixel.

The descriptions provided with reference to FIGS. 1 and 5 may be applied to the method of FIG. 6 and thus, duplicated descriptions will be omitted for conciseness.

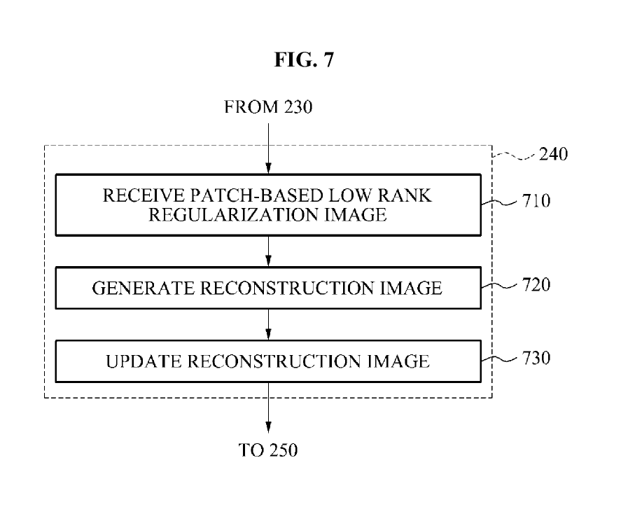

FIG. 7 is a flowchart illustrating a method of updating a reconstruction image according to an embodiment of the present invention.

Operation 240 of FIG. 2 may include operations 710 through 730 of FIG. 7.

Referring to FIG. 7, in operation 710, the processor 120 may receive the patch-based low rank regularization image generated in operation 230 of FIG. 2 to update a reconstruction image.

In operation 720, the processor 120 may generate a reconstruction image using a probability model based expectation maximization algorithm.

The probability model based expectation maximization algorithm used in operation 220 of FIG. 2 may be applied to operation 720. The reconstruction image generated in operation 720 may correspond to the initial reconstruction image generated in operation 220, or a reconstruction image generated and updated after operations 230 through 250 of FIG. 2 are performed at least once.

In operation 730, the processor 120 may update the reconstruction image based on the received patch-based low rank regularization image and the probability model based expectation maximization algorithm.

An operation that updates a reconstruction image based on a patch-based low rank regularization image and a probability model based expectation maximization algorithm may be expressed by Equation 5.

$${x}_{ns}^{( k + 1 )} = \frac{- {b}_{ns}^{( k + 1 )} + \sqrt{{( {b}_{ns}^{( k + 1 )} )}^{2} + 4 {d}_{ns} {x}_{ns}^{EM ( k + 1 )} {\sum }_{m = 1}^{M} {a}_{mn}}}{2 {d}_{ns}} , \\ and \\ {d}_{ns} \text{:} \frac{1}{μ} {\sum }_{p ∈ {I}_{ns}}^{ } {λ}_{p} , \\ {b}_{ns}^{( k + 1 )} = {\sum }_{m}^{ } {a}_{mn} - \frac{1}{μ} {\sum }_{p ∈ {I}_{ns}}^{ } {λ}_{p} {w}_{p , ns}^{( k + 1 )} \qquad [ Equation 2 ]$$

In Equation 5, n denotes an index indicating an n-th voxel.

s denotes a predetermined time frame, and m denotes an index indicating an m-th detector.

xₙₛ^{(k+1)} denotes an unknown image in the n-th voxel and the time s in a (k+1)-th iteration. xₙₛ^{EM(k+1)} denotes a value of an MLEM image in the n-th voxel and the time s in the (k+1)-th iteration. aₘₙ denotes a probability of a photon, emitted from the n-th voxel, being detected at a location of the m-th detector.

μ denotes a factor associated with a quality of image. μ may correspond to a predetermined value selected by a trial and error method based on intensities of patches.

p denotes an index indicating a p-th reference patch.

λ denotes an imposition of a balance factor between loglikelihood and low-rank regularization conditions.

w_{p,ns}^{(k+1)} denotes a predetermined element of a p-th patch having contributions with respect to the n-th voxel at the time s after the low-rank constrained shrinkage operation of Equation 2 is performed in the (k+1)-th iteration.

The processor 120 may select a value of λ to satisfy Equation 6 with respect to a predetermined value c.

Σ_{pεI}_{_{νs}}λωₚ=c·Σₘ₌₁^{M}aₘₙ [Equation 6]

λₚ denotes A, with respect to the p-th reference patch.

Iₙₛ denotes a set of patch indices that enables xₙₛ to be used within similar patches.

aₘₙ denotes a probability of a photon, emitted from the n-th voxel, being detected at a location of the m-th detector.

Σ_{pεI}_{_{—}}ₙₛwₚ denotes the final w_{p,ns}.

When the processor 120 determines in operation 250 of FIG. 2 that the reconstruction image updated in operation 730 does not converge, the updated reconstruction image may be used as a reconstruction image to perform operations 230 and 240. When the processor 120 determines that the reconstruction image updated in operation 730 converges, the updated reconstruction image may correspond to a desired reconstruction image.

The descriptions provided with reference to FIGS. 1 and 6 may be applied to the method of FIG. 7 and thus, duplicated descriptions will be omitted for conciseness.

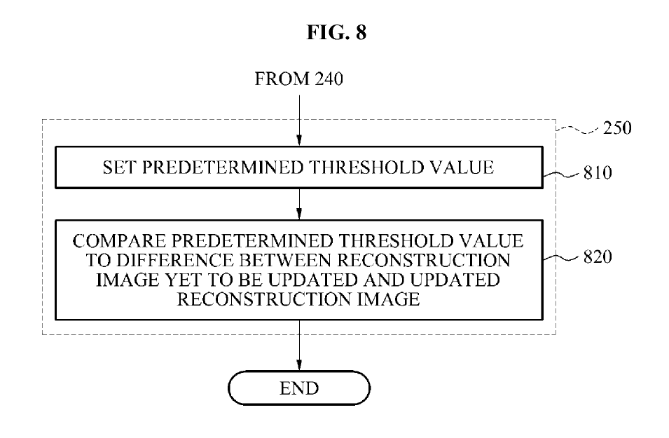

FIG. 8 is a flowchart illustrating a method of determining whether an updated reconstruction image converges according to an embodiment of the present invention.

Operation 250 of FIG. 2 may include operations 810 and 820 of FIG. 8.

Referring to FIG. 8, in operation 810, the processor 120 may set a predetermined threshold value to determine whether an updated reconstruction image converges.

In operation 820, the processor 120 may determine whether the updated reconstruction image converges by comparing the predetermined threshold value to a difference between the reconstruction image yet to be updated and the updated reconstruction image.

For example, the predetermined threshold value may correspond to a mean square error less than or equal to a predetermined value.

The processor 120 may verify whether a mean square error of the difference between the reconstruction image yet to be updated and the updated reconstruction image is less than or equal to the predetermined threshold value.

The CPU 130 may determine that the updated reconstruction image converges when the mean square error of the difference between the reconstruction image yet to be updated and the updated reconstruction image is less than or equal to the predetermined threshold value.

The operations described above may be performed by the CPU 130 or the GPU 140, in lieu of the processor 120. The processor 120, the CPU 130, and the GPU 140 may be used interchangeably.

The descriptions provided with reference to FIGS. 1 and 7 may be applied to the method of FIG. 8 and thus, duplicated descriptions will be omitted for conciseness.

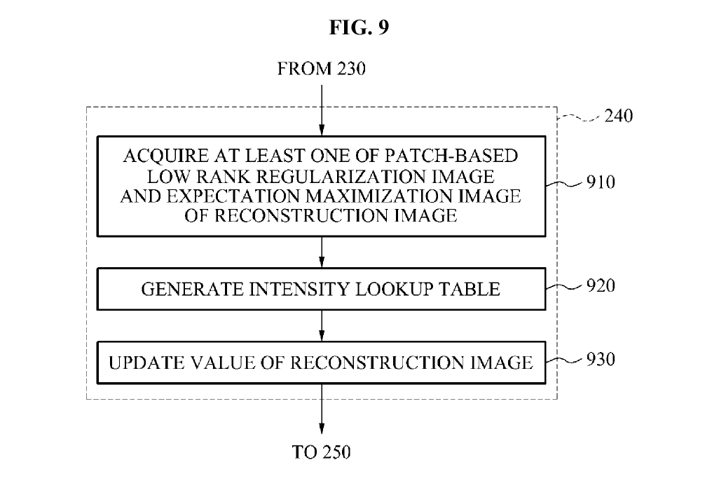

FIG. 9 is a flowchart illustrating a method of updating a reconstruction image using a convergence guarantee algorithm according to an embodiment of the present invention.

Operation 240 of FIG. 2 may include operations 910 through 930 of FIG. 9.

In operation 240, the processor 120 may update a reconstruction image using a convergence guarantee algorithm based on an expectation maximization image of the reconstruction image and the patch-based low rank regularization image generated in operation 230. The convergence guarantee algorithm may refer to an algorithm that prevents a divergence of a value of the reconstruction image updated by an iterative performance of operation 240. The processor 120 may update the reconstruction image using the convergence guarantee algorithm, whereby the value of the updated reconstruction image may not diverge but converge. A value of an image may correspond to a value of each pixel.

Referring to FIG. 9, in operation 910, the processor 120 may acquire at least one of a patch-based low rank regularization image and an expectation maximization image of a reconstruction image. The expectation maximization image may be acquired from the reconstruction image using a probability model based expectation maximization algorithm. The acquisition of the expectation maximization image may correspond to a reception of an expectation maximization image pre-generated from the reconstruction image.

In operation 920, the processor 120 may generate an intensity lookup table for a sum of a value based on the expectation maximization image of the reconstruction image, a value based on a log value of the reconstruction image, and a value based on the patch-based low rank regularization image. As described above, operation 240 may be performed iteratively, and the intensity lookup table may be updated each time operation 240 is performed.

In operation 930, the processor 120 may update a value of the reconstruction image based on a value of the intensity lookup table generated in operation 920.

A relationship between a value Tₓ_{^{k}} of an intensity lookup table and a value x^{k+1} of an updated reconstruction image with respect to a reconstruction image x^{k} may be defined as expressed by Equation 7.

Tₓ_{^{k}}=c₁x^{k+1}+c₂ log x^{k+1} [Equation 7]

In Equation 7, c₁ and c₂ may respectively correspond to a constant value or a variable value that varies based on an iterative performance of operation 240.

c₁ and c₂ may be defined as expressed by Equations 8 and 9, respectively.

$$\begin{matrix}{c}_{1} = ( 1 + \frac{1}{μ} {\sum }_{p ∈ {I}_{ns}}^{ } {λ}_{p} ) & [ Equation 8 ] \\ {c}_{2} = {\overline{y}}_{j} / {c}_{k} & [ Equation 9 ]\end{matrix}$$

In Equation 9, cₖ may correspond to a constant. y̅ⱼ may be defined as expressed by Equation 10.

y̅ⱼ=Σᵢ₌₁^{M}yᵢ/Σⱼ₌₁ⁿaᵢⱼ [Equation 10]

Equation 7 may also be expressed as Equation 11.

$$( 1 + \frac{1}{μ} {\sum }_{p ∈ {I}_{ns}}^{ } {λ}_{p} ) {x}_{ns}^{k + 1} + \frac{{\overline{y}}_{j}}{{c}_{k}} log {x}_{j}^{k + 1} = {x}_{ns}^{EM , ( k + 1 )} + \frac{1}{μ} {\sum }_{p ∈ {I}_{ns}}^{ } {λ}_{p} {w}_{p , ns}^{k + 1} + \frac{{\overline{y}}_{j}}{{c}_{k}} log {x}_{j}^{k} \qquad [ Equation 11 ]$$

In Equation 11, j denotes a voxel. xⱼ^{k} denotes a value of a reconstruction image in a j-th voxel. The j-th voxel may correspond to an n-th voxel at a time s. xⱼ^{k} may be identical to xₙₛ^{k}. A value on a right side of Equation 11 may be obtained with respect to a provided xⱼ^{k}. For example, the processor 120 may obtain the value of the right side of Equation 11 with respect to each xⱼ^{k} by changing a value of xⱼ^{k} by a predetermined value, and may generate the intensity lookup table based on the value of the right side of Equation 11 obtained for each xⱼ^{k}.

The processor 120 may obtain the value of the updated reconstruction image by obtaining values of the intensity lookup table and a value of Xₙₛ^{(k+1)} using Equation 11. The processor 120 may update the reconstruction image by obtaining the value of the updated reconstruction image for each pixel.

The descriptions provided with reference to FIGS. 1 and 8 may be applied to the method of FIG. 9 and thus, duplicated descriptions will be omitted for conciseness.

According to exemplary embodiments, it is possible to provide an image reconstruction method and apparatus that may reduce noise and increase a resolution of a reconstruction image using a patch-based low rank regularization.

According to exemplary embodiments, it is also possible to provide an image reconstruction method and apparatus using a patch-based low rank regularization that may reduce an operation processing time by processing operations in parallel.

According to exemplary embodiments, it is also possible to provide an image reconstruction method and apparatus that may prevent a divergence of an image to be reconstructed by reconstructing an image optimized based on a convergence guarantee algorithm.

The method according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An image reconstruction method performed by an image reconstruction apparatus, the method comprising:
receiving a plurality of sinograms generated by measuring an object at different times;
computing an initial reconstruction image based on the received sinograms;
generating a patch-based low rank regularization image based on the initial reconstruction image; and
updating the initial reconstruction image based on the patch-based low rank regularization image.

2. The method of claim 1, wherein the initial reconstruction image corresponds to a four-dimensional (4D) image generated by individually reconstructing a plurality of three-dimensional (3D) images generated based on the plurality of sinograms for each time.

3. The method of claim 2, wherein the computing comprises reconstructing the plurality of 3D images into the 4D image using a probability model based expectation maximization algorithm.

4. The method of claim 1, further comprising:
determining whether the updated reconstruction image converges,
wherein, when the updated reconstruction image does not converge, the generating and the updating are performed iteratively.

5. The method of claim 4, wherein the determining comprises:
setting a predetermined threshold value to determine whether the updated reconstruction image converges; and
verifying whether a mean square error of a difference between the initial reconstruction image yet to be updated and the updated reconstruction image is less than or equal to the threshold value,
wherein the determining comprises determining that the updated reconstruction image converges when the mean square error is less than or equal to the threshold value.

6. The method of claim 1, wherein the generating comprises:
determining a reference patch within the initial reconstruction image;
collecting a predetermined number of patches most similar to the reference patch;
generating a patch matrix by vectorizing the similar patches;
obtaining eigenvalues of the patch matrix by performing a singular value decomposition (SVD) operation on the patch matrix;
obtaining minimized eigenvalues by performing a minimization operation on the eigenvalues; and
generating the patch-based low rank regularization image based on the minimized eigenvalues.

7. The method of claim 6, wherein the determining of the reference patch comprises:
generating threads corresponding to a number of pixels of the initial reconstruction image; and
matching the plurality of threads to patches in which the pixels are disposed at respective centers thereof.

8. The method of claim 7, wherein the plurality of threads is processed by a plurality of cores of a graphics processing unit (GPU) of the image reconstruction apparatus, respectively.

9. The method of claim 6, wherein the collecting comprises:
identifying all adjacent temporal and spatial patches within a predetermined search area from the reference patch in the initial reconstruction image;
calculating similarities between the reference patch and the adjacent temporal and spatial patches; and
extracting the predetermined number of similar patches from the adjacent temporal and spatial patches based on the calculated similarities.

10. The method of claim 6, wherein the obtaining of the minimized eigenvalues comprises obtaining the minimized eigenvalues by eliminating eigenvalues less than or equal to a predetermined threshold value, among the eigenvalues.

11. The method of claim 6, wherein the generating of the patch-based low rank regularization image based on the minimized eigenvalues comprises:
generating a corrected matrix by multiplying the minimized eigenvalues by eigenvectors;
converting columns of the corrected matrix into correction patches to be used to generate the patch-based low rank regularization image;
adding each of the correction patches at a location corresponding to each of the correction patches in the initial reconstruction image; and
dividing each pixel value by a number of correction patches added to each pixel, for all pixels of the initial reconstruction image to which the correction patches are added.

12. The method of claim 1, wherein the updating comprises:
acquiring an expectation maximization image of the reconstruction initial image;
generating an intensity lookup table for a sum of a value based on the expectation maximization image, a value based on a log value of the initial reconstruction image, and a value based on the patch-based low rank regularization image; and
updating a value of the initial reconstruction image based on a value of the intensity lookup table.

13. The method of claim 12, further comprising:
determining whether the updated value of the initial reconstruction image converges,
wherein, when the updated value of the initial reconstruction image does not converge, the generating and the updating are performed iteratively, and
the intensity lookup table is updated each time the updating of the initial reconstruction image is performed.

14. The method of claim 13, wherein a relationship between a value Tₓ_{^{k}} of the intensity lookup table and a value x^{k+1} of an updated reconstruction image with respect to a reconstruction image x^{k} is defined as expressed by Equation 1,
Tₓ_{^{k}}=c₁x^{k+1}+c₂ log x^{k+1} [Equation 1]
wherein c₁ and c₂ respectively correspond to a constant value or a variable value that varies based on an iterative performance of the updating of the initial reconstruction image.

15. A method for convergence guaranteed image reconstruction, performed by an image reconstruction apparatus, the method comprising:
receiving a plurality of sinograms generated by measuring an object at different times;
computing an initial reconstruction image based on the received sinograms;
generating a patch-based low rank regularization image based on the initial reconstruction image;
updating the initial reconstruction image using a convergence guarantee algorithm based on the patch-based low rank regularization image and an expectation maximization image of the initial reconstruction image; and
determining whether the updated reconstruction image converges,
wherein, when the updated reconstruction image does not converge, the generating and the updating are performed iteratively.

16. The method of claim 15, wherein the updating comprises:
generating an intensity lookup table for a sum of a value based on the expectation maximization image, a value based on a log value of the initial reconstruction image, and a value based on the patch-based low rank regularization image; and
updating a value of the initial reconstruction image based on a value of the intensity lookup table,
wherein the intensity lookup table is updated each time the updating is performed.

17. The method of claim 16, wherein a relationship between a value Tₓ_{^{k}} of the intensity lookup table and a value x^{k+1} of an updated reconstruction image with respect to a reconstruction image x^{k} is defined as expressed by Equation 2,
Tₓ_{^{k}}=c₁x^{k+1}+c₂ log x^{k+1} [Equation 2]
wherein c₁ and c₂ respectively correspond to a constant value or a variable value that varies based on an iterative performance of the updating of the initial reconstruction image.

18. The method of claim 15, wherein a divergence of a value of the initial reconstruction image updated by an iterative performance of the updating of the initial reconstruction image is prevented using the convergence guarantee algorithm.

19. An image reconstruction apparatus comprising:
a receiver to receive a plurality of sinograms generated by measuring an object at different times;
a central processing unit (CPU); and
a graphics processing unit (GPU),
wherein the GPU comprises a plurality of cores,
the CPU computes an initial reconstruction image based on the received sinograms, generates a patch-based low rank regularization image based on the initial reconstruction image, and updates the initial reconstruction image based on the patch-based low rank regularization image, and
the plurality of cores of the GPU executes in parallel a plurality of threads to be used to compute the initial reconstruction image.
